(19) United States
(12) Patent Application Publication
(10) Pub. No.: US 2026/0121869 A1
(43) Pub. Date: Apr. 30, 2026

(54) SECURE AND AUTOMATED DISTRIBUTION OF ROOT CA CERTIFICATES FOR OPERATOR-BOUND COMPONENTS

(71) Applicant: Dell Products L.P., Round Rock, TX (US)

(72) Inventors: Hongsoon Kwon, Porter Ranch, CA (US); Judith A. Furlong, Natick, MA (US); Michael Rash, Mount Airy, MD (US)

(21) Appl. No.: 18/926,480

(22) Filed: Oct. 25, 2024

(51) Int. Cl. H04L 9/32

(52) U.S. Cl. CPC H04L 9/3265; H04L 9/3268

(57) ABSTRACT

A private certificate database which stores the root CA certificates from many certification authorities (CAs) is created and a server handles operations of assembling and distributing the set of root CA certificates to components in the system. The private certificate database is associated with a CA and a service that are configured to issue certificates to the component to enable secure communications between the component and this PCDB system. The private certificate database can then distribute root CA certificates to components in a system such that the components can interact. This relieves the manufacturer from having to configure the local root certificate stores of the components in the system. The root CA certificates can be distributed in accordance with binding data, which determines which of the components can interact with which of the other components. Further, unauthorized components are prevented from being added to the system.

### TECHNOLOGICAL FIELD OF THE DISCLOSURE

Embodiments disclosed herein generally relate to certificate or digital signature based systems, methods, and/or operations. More particularly, at least some embodiments relate to systems, hardware, software, computer-readable media, and methods for securely distributing root CA (Certification Authority) certificates in a computing system, network, or environment.

### BACKGROUND

Public key infrastructure (PKI) is a framework that is used for secure communications in computing networks. PKI relies on asymmetric key pairs. Each key pair includes a public key and a private key. The private key is kept secret and secure by the key holder while the public key may be shared with others. In PKI frameworks, a digital certificate identifies an identity of an entity (the key holder) and the entity obtains the digital certificate from a certification authority. The certification authority, before issuing the certificate, verifies the identity of the entity seeking the digital certificate. A digital certificate includes, by way of example only, an entity name, the public key of the entity, a name of the issuer (the CA, which may be an intermediate CA), and a signature of the issuer.

A common component of PKI is a local root store configured to store root CA certificates. A root CA certificate, generally, is a digital certificate that belongs to a trusted CA. For public certificate authorities, vendor root programs (e.g., Common CA Database, Apple Trusted Roots) facilitate the distribution of root CA certificates. Root CA certificates, for example, are often distributed as part of an operating system or browser and are trusted out-of-the-box.

For components and operators participating in a system with a private CA that is not a public CA, the local root CA certificate stores need to receive a root CA certificate of the private CA. The local root CA certificate store can be constructed in various manners. For example, a manufacturer of a component may collect root CA certificates and install the collected root CA certificates in the local root CA certificate store of the component. This may allow the component to interact with other components in a system once the component is deployed or onboarded into the system. The root CA certificates that are collected by the manufacturer are installed in the manufacturer’s components at the factory prior to shipping/deployment.

One of the difficulties with this approach is that the root CA certificates collected and installed in a component are the ones known to the manufacturer and may not include root CA certificates needed by the component. When the component is shipped and installed in a system, that component may need to interact with a component from a different manufacturer. This may lead to a situation where an interaction between these two components fails because the required root CA certificate is not available.

As a result, the operator of the system is required to manually edit the local root CA certificate store (e.g., install missing root CA certificates, remove unnecessary root CA certificates) of the individual components such that component interactions may occur and to improve security. This is tedious and prone to user-error.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a certificate chain;

FIG. 2 discloses aspects of a system that includes and implements a private certificate database system;

FIGS. 3A, 3B, 3C, 3D and 3E disclose aspects of provisioning and/or updating local root CA certificate stores of components in a system;

FIGS. 4A, 4B, 4C and 4D disclose additional aspects of provisioning and/or updating local root CA certificate stores of components in a system; and

FIG. 5 discloses aspects of a computing device, system, and/or entity.

### DETAILED DESCRIPTION OF SOME EXAMPLE EMBODIMENTS

Embodiments disclosed herein generally relate to installing and distributing certificates in a computing environment. More particularly, at least some embodiments relate to systems, hardware, software, computer-readable media, and methods for installing root CA (Certification Authority) certificates in components of a computing system or network.

Conventionally, a public root CA has or is associated with vendor root programs to facilitate and automate the distribution of root CA certificates. A private CA, however, is unable to distribute root CA certificates in a similar manner. As a result, root CA certificates for a private CA are distributed manually using out-of-band processes. When a local root CA certificate store of a component is configured at the factory, the root CA certificates that should be stored in the local root CA certificate store may not be known until later in the lifecycle of the component. This may force an operator to update the local certificate store manually one or more times and may lead to problems or failures in the system in which the component is installed.

In one example embodiment, an operator of a system may create a private certificate database (PCDB). The private certificate database is configured to store root CA certificates that may be needed by components of the system and/or by the operator. The private certificate database is configured to facilitate the distribution of root CA certificates to components in a system. Embodiments of the invention relieve the component manufacturer of the responsibility of populating the local root stores of their components and allow the components to work within the framework of the PKI infrastructure of a private CA.

Embodiments of the invention allow the private CA to issue certificates to components or entities that seek service from the private CA.

The private certificate database may be configured as a system-wide root CA certificate repository and enables asynchronous collection of root CA certificates from other sources (e.g., other CAs). Advantageously, the private certificate database enables components of a system to communicate or interact with other components regardless of manufacturer and regardless of the CAs used by the manufacturers.

The private certificate database may be configured to include lists that are tailored to match the components that are deployed in an operator or private network environment with certificates that the components require to operate in the system. The private certificate database allows components to automatically acquire trusted root CA certificates throughout their deployment/lifetime. This allows a component to adapt to changes in a system and interact with other components in the same system. The component may also be reconfigured, from a root CA certificate perspective, if moved to another system.

Embodiments of the invention further relate to a private certificate database that is specific to a particular system or that is able to operate with multiple systems.

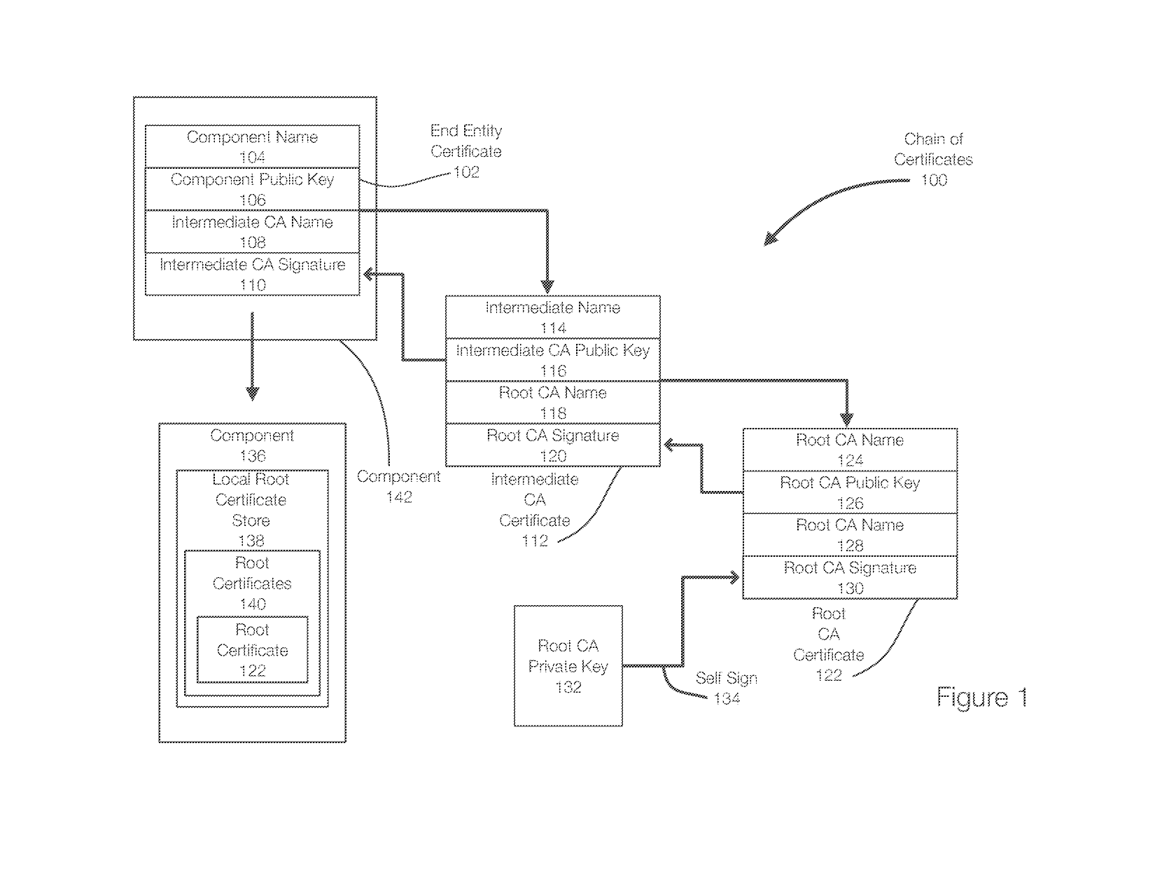

FIG. 1 discloses aspects of verifying a certificate using a certificate chain and a local root CA certificate store. In the example of FIG. 1, an end entity (e.g., a component 142 in a system) presents a certificate (the end entity certificate 102) to another component 136 that is also part of the same system as the end entity.

Prior to validating or verifying the chain of certificates 100, the chain of certificates 100 is built. Once the chain 100 built, the chain of certificates 100 is rooted in a trust anchor trusted by the entity performing the verification (the component 136 in this example).

In this example, the chain of certificates 100 is associated with the end entity certificate 102 and includes an intermediate CA certificate 112 (or multiple intermediate certificates), and a root CA certificate 122. By way of example, the end entity certificate 102 belongs to the component 142, the intermediate CA certificate 112 may belong to an operator (e.g., an operator of a system) or a manufacturer of the component 142, and the root CA certificate 122 belongs to a trusted CA. Regardless of who owns the intermediate CA certificate 112, the verification of the chain of certificates 100 may be performed in the same manner.

The chain of certificates 100 is verified by the component 136 in FIG. 1. In this example, the end entity certificate 102 is presented to the component 136. The end entity certificate 102, by way of example, may include a component name 104, a component public key 106, and intermediate CA name 108, and an intermediate CA signature 110.

To verify the chain of certificates 100, the component 136 walks the chain of certificates 100 from the end entity certificate 102 to the root CA certificate 122. The component 136 may ensure that the certificates 102, 112, and 122 are valid (e.g., not expired) and determine or identify the issuers thereof. This type of information is included in the certificates. Similar to the end entity certificate 102, the intermediate CA certificate 112 includes an intermediate name 114, an intermediate CA public key 116, a root CA name 118, and a root CA signature 120 and the root CA certificate 122 follows a similar format and includes a root CA name 124, a root CA public key 126, a root CA name 128, and a root CA signature.

When the root CA certificate 122 is reached, the root CA is trusted at least because the root CA certificate 122 is stored in the local root CA certificate store 138. More specifically, the local root store 138 includes copies of root CA certificates 140 that are trusted by the component 136 including, in this example, the root CA certificate 122. When the component 136 reaches the root CA certificate 122 in the chain 100 and the root CA certificate 122 is stored in the local root store 138 of the component 136, the chain of certificates 100 is then walked in reverse.

Next, the signatures are verified in the reverse order. The root CA public key 126 from the copy of the root CA certificate 122 stored in the local root CA certificate store 138 is used to verify the root CA signature 120 in the intermediate CA certificate 112. For example, the root CA public key 126 is used to decrypt the root CA signature 120. This may generate a decrypted hash of the intermediate CA certificate 112. The component 136 may independently generate a hash of the same information of the intermediate CA certificate 112 and if the two hashes match, the component 136 is assured that the issuer identified by the root CA name 124, signed the intermediate CA certificate 112. The intermediate CA signature 110 in the end entity certificate 102 is verified in a similar manner using the intermediate CA signature 110 and the intermediate CA public key 116.

After the chain of certificates 100 is verified successfully, the component 142 is trusted by the component 136. If the root CA certificate 122 is not present in the local root store 138 or if any of the certificates in the chain of certificates 100 cannot be verified, the component 142 is not trusted by the component 136.

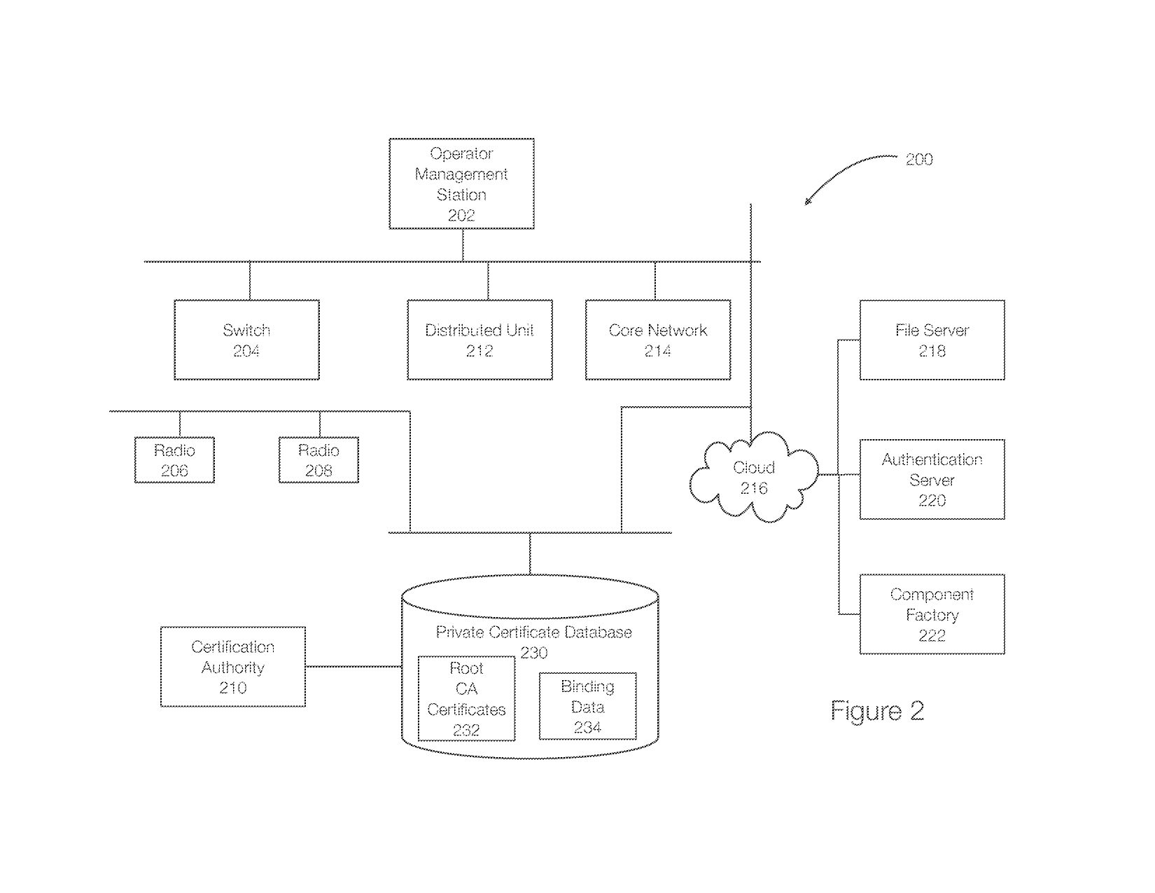

FIG. 2 discloses aspects of a private certificate database system that includes a private certificate database (e.g., a PCDB). The private certificate database system is deployed to a system 200. The system 200, by way of example, may be an O-RAN (or RAN) network, which may include telecommunications or cellular networks. Embodiments of the invention, however, may be implemented in other networks including wide area networks, local area networks, or the like. The connections may include wireless and/or wired connections.

In the system 200 (e.g., an O-RAN system or network) and by way of example only, components such as switches (represented by the switch 204), radios (represented by the radios 206 and 208, distributed units 212, core network 214 (may include multiple components) are regularly installed, replaced, removed, updated, upgraded, or the like. As these types of changes occur in the system 200, components from various sources (e.g., different manufacturers) may be used. Embodiments of the invention relate to a private CA that is configured to help ensure that the components in the system 200 are able to interact or communicate with other components in the system.

The system 200 may have access to or include various servers such as a file server 218, an authentication server 220, and a component factory 222, which are also examples of components. Interactions between the components in the system 200 may be facilitated using certificates. Certificates may be used, by way of example, for authentication purposes, encryption purposes, data integrity purposes, software distribution purposes, or the like or combinations thereof.

In one example, each of the components in the system 200 may have their own local root CA certificate store. An operator, via an operator management station 202 in one example, may create a private certificate database 230 (PCDB). The private certificate database 230 is configured to manage and/or distribute root CA certificates to components in the system 200.

The private certificate database 230 stores root CA certificates 232 and binding data 234. The binding data 234 may identify the interaction or communication requirements/permissions for the components in the system 200. The binding data 234 may include a list, by way of example, for each component in the system 200. The list includes or identifies components with which the component may interact or communicate. The binding data 234 may be used when distributing the root CA certificates 232 to the components in the system 200. For example, if the binding data 234 indicates that the switch 204 needs to communicate with the radio 208, the local root stores of the switch 204 and the radio 208 are provided with the relevant root CA certificates stored in the private certificate database 230.

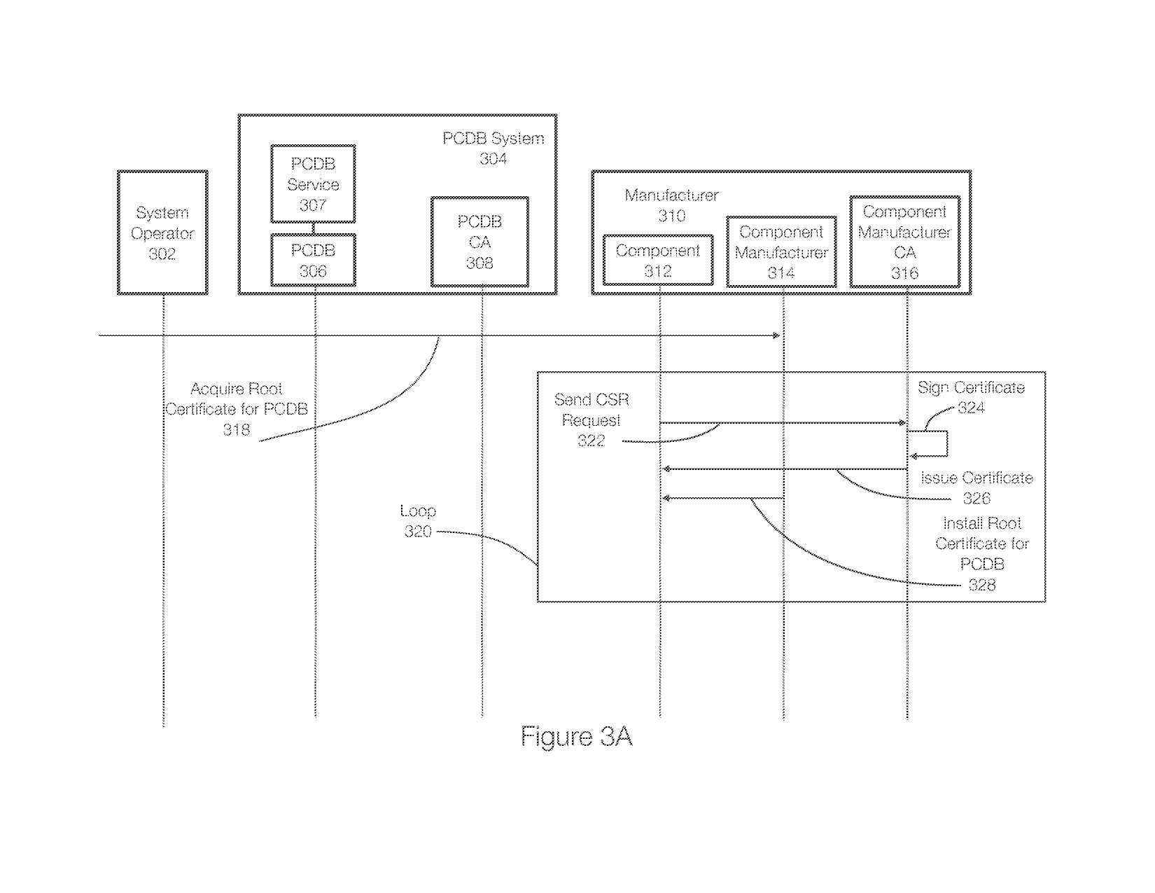

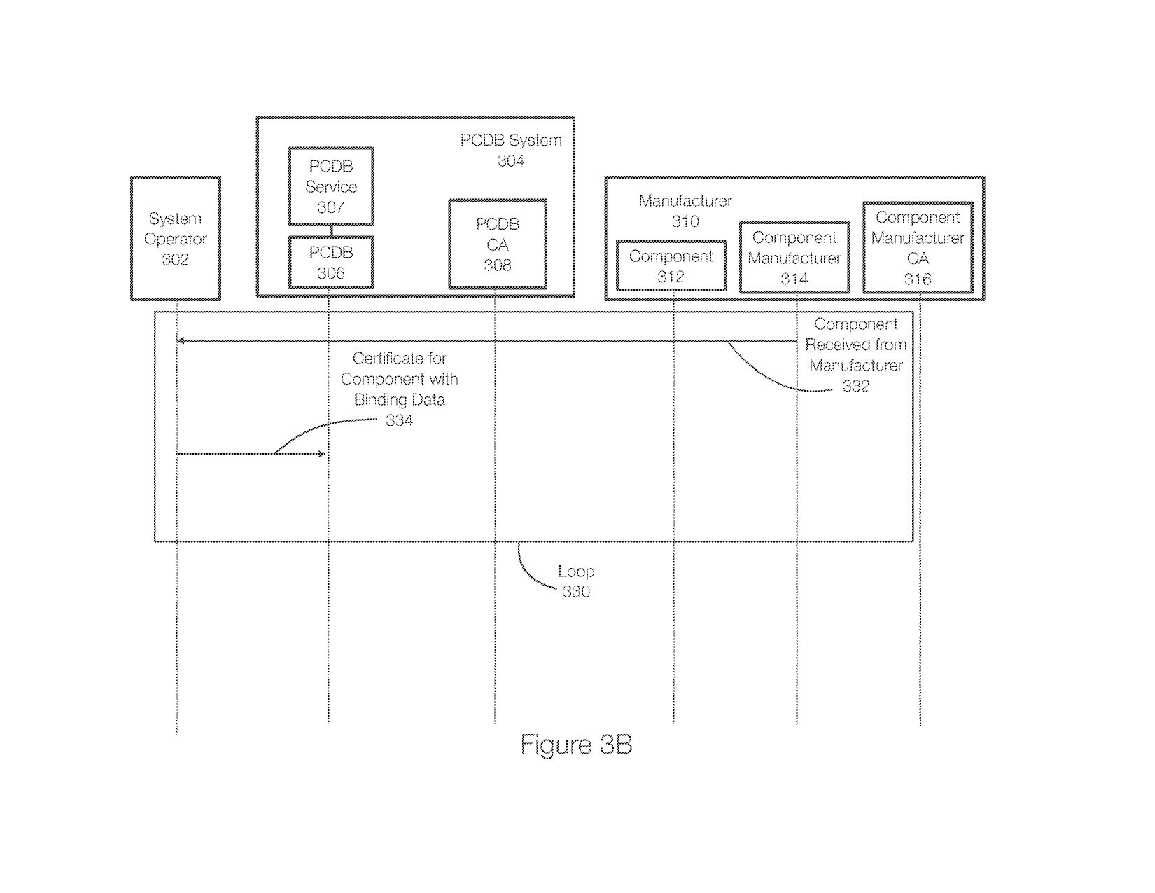

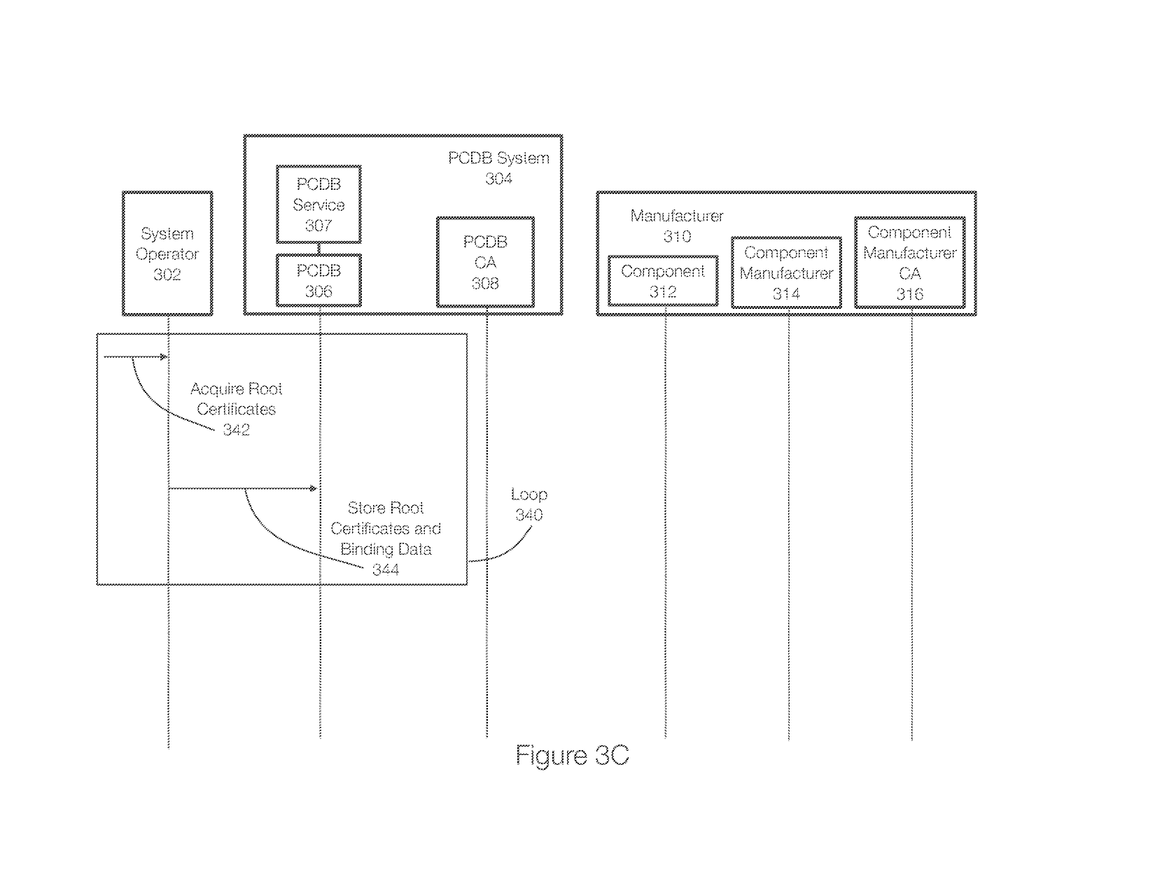

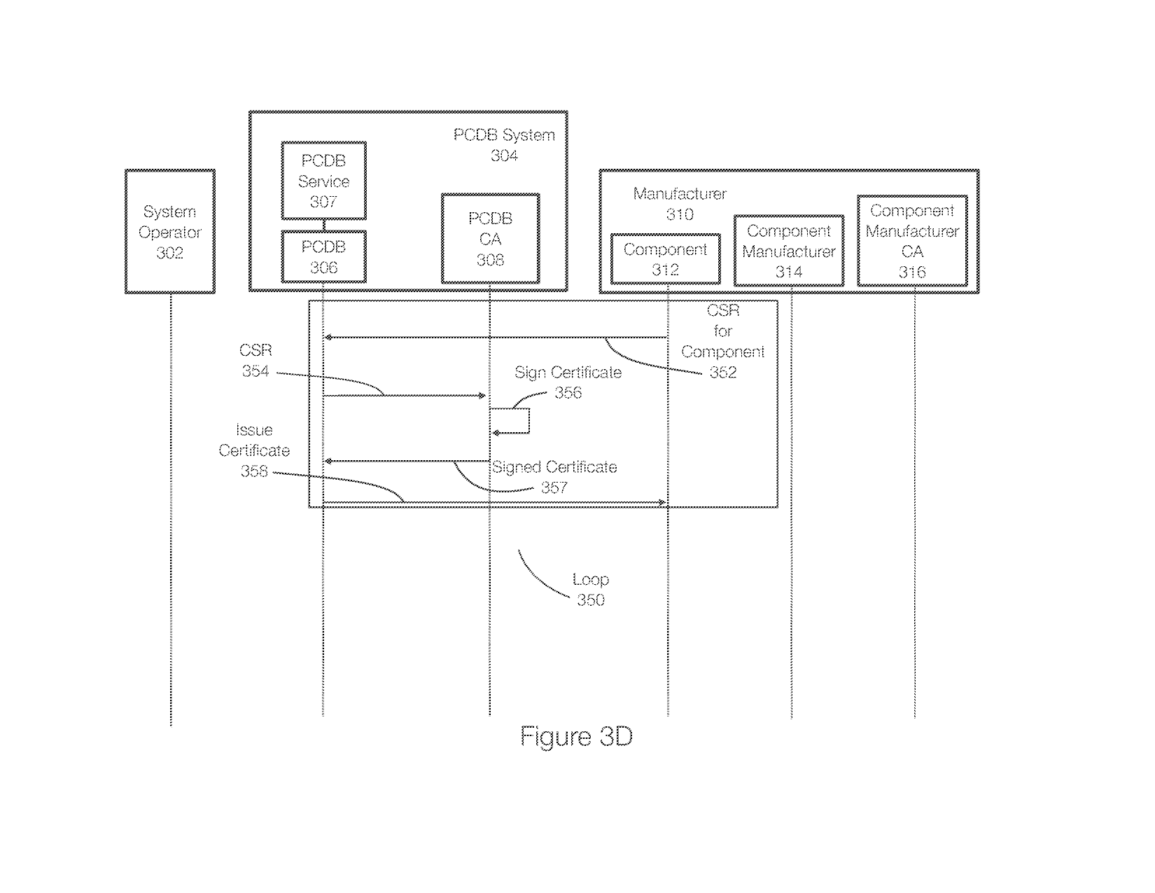

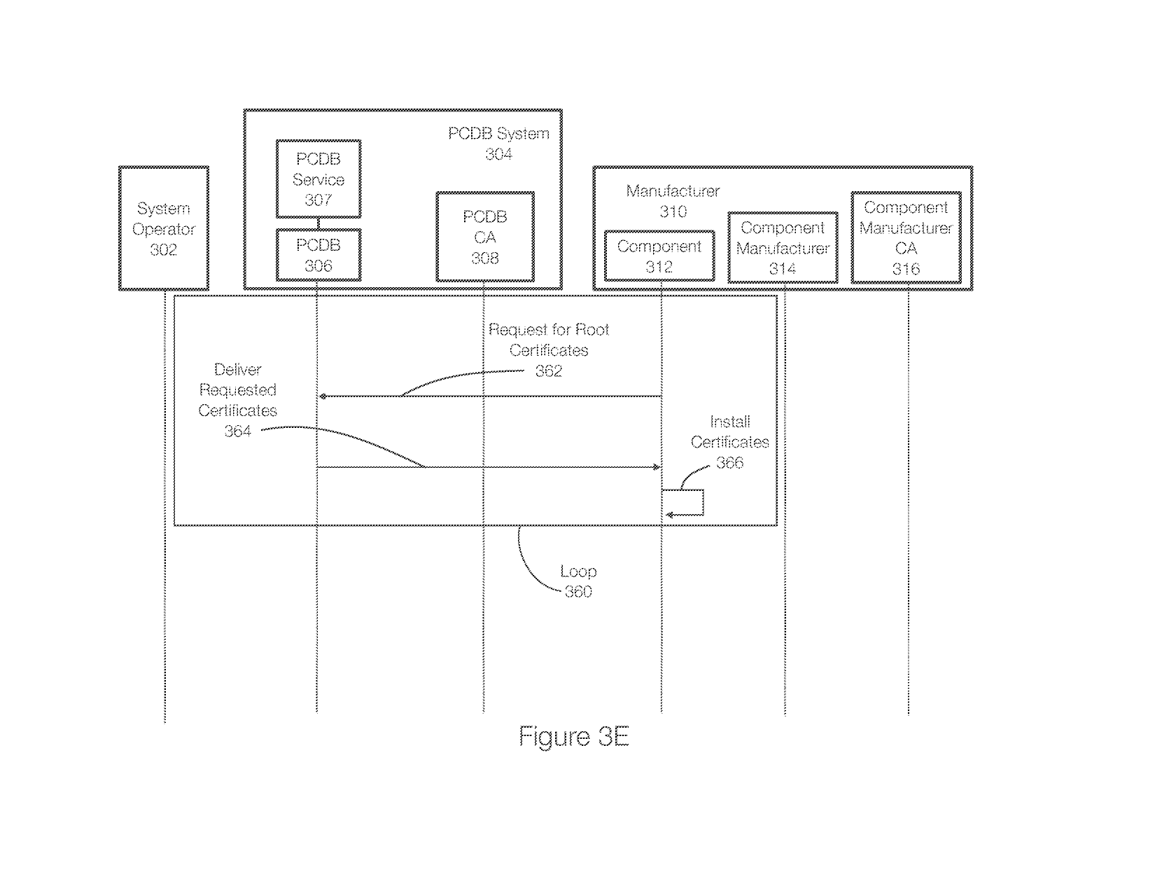

FIGS. 3A, 3B, 3C, 3D and 3E, disclose aspects of, by way of example, provisioning and/or updating local root CA certificate stores of components in a system. FIGS. 3A-3E more specifically illustrate aspects of provisioning/updating local root CA certificate stores of components in a system in a scenario where a manufacturer (e.g., component factory) does not have access to the private certificate database (the PCDB).

FIGS. 3A-3E illustrate interactions, communications, and/or relationships between a system operator 302, PCDB System 304, which includes a private certificate database (PCDB) 306 operated or managed by a PCDB service 307, and a certification authority (CA) (PCDB CA) 308 in the context of manufacturer 310, represented by component 312, a component manufacturer 314, and a component manufacturer CA 316.

FIGS. 3A-3E each illustrate a different phase of a method for provisioning and/or updating local root certificate stores of components in a system. FIGS. 3A-3E further include loops that may be applied to multiple components from multiple manufacturers or suppliers. However, FIGS. 3A-3E are typically explained with respect to a particular component manufactured by a particular manufacturer.

The method illustrated in FIG. 3A includes acquiring a root CA certificate of a PCDB system 304. More specifically, a component manufacturer 314 acquires 318 the root CA certificate of the PCDB system 304 in an out-of-band manner in this example.

Once the root CA certificate of the PCDB system 304 is acquired, a loop 320 may be performed for components, such as the component 312, being manufactured or prepared for delivery. The elements of the loop 320 are performed after the component 312 and the component manufacturer 314 authenticate each other, for example using pre-shared keys.

Once authentication is performed successfully, the component 312 requests or sends 322 a certificate signing request (CSR) to a component manufacturer CA 316 (e.g., the CA used by the manufacturer). The component manufacturer CA 316 signs 324 the certificate and issues 326 the certificate to the component 312.

Thus, the component 312 has its own digital certificate, signed and issued by the component manufacturer CA 316, that can be presented to other components. Further, the root CA certificate for the PCDB system 304 (previously acquired 318) is installed 328 by the component manufacturer 314 in a local root CA certificate store of the component 312. FIG. 3A thus illustrates a process for installing a root CA certificate of the PCDB system 304 in a local certificate store of the component 312.

FIG. 3B illustrates that the component 312 is shipped or delivered to the system operator. The loop 330, as a result, is performed outside of the factory. In the loop 330, which is performed for components received from the component manufacturer 314, the operator receives 332 the component 312 from the component manufacturer 314. The system operator 302 adds 334 the component’s certificate, issued by the component manufacturer CA 316, and binding information to the PCDB 306. The binding data may identify components with which the component 312 may interact. The binding data may be identified and/or generated by the system operator 302 and may include components from multiple manufacturers. The loop 330 may be performed for all components received from multiple manufacturers.

FIG. 3C discloses a phase where root CA certificates for components in the system are collected by the operator 302. In the loop 340, which is performed for components received from the component manufacturer 314 (and other components/component manufacturer), root CA certificates are acquired 342 using a secure mechanism and stored 344 in the PCDB 306 along with the corresponding binding data provided by the operator. For example, the operator 302 may acquire a root CA certificate of the component manufacturer CA 316 and may acquire root CA certificates associated with other manufacturer CAs.

Thus, in this example, the loop 340 includes acquiring 342 root CA certificates of other CAs. The system operator 302 may acquire 342 root CA certificates at a different time and/or independently of the loop 340. The root CA certificates acquired by the system operator 302 are then stored in the PCDB 306. This allows the PCDB 306 to be populated with root CA certificates of multiple component manufacturer CAs including the component manufacturer CA 316.

FIG. 3D discloses aspects of acquiring a certificate for operation within the context of the PKI framework of the PCDB system 304. Before performing the loop 350, the PCDB 306 and the component 312 authenticate using certificates in one example embodiment. For example, the PCDB 306 authenticates by presenting the component 312 with the root CA certificate of the PCDB system 304 (or more specifically of the PCDB 306). Because the root CA certificate was already installed in the component 312, the component 312 can authenticate the PCDB 306. Similarly, the component 312 may present the certificate issued by the component manufacturer CA 316. The PCDB 306 has both the root CA certificate of the component manufacturer CA 316 and a copy of the certificate that was issued to the component 312 by the component manufacturer CA 316. Thus, the PCDB 306 can authenticate the component 312.

Once authentication is completed successfully, the loop 350 may be performed for all components received by the operator. The loop 350 allows authentication operations performed after the component 312 is onboarded to be free from external CAs (e.g., outside of the private CA 304), such as the component manufacturer CA 316. The loop 350 allows the private CA 304 to issue a certificate to the component 312 within its own PKI framework. All authentication or certification verification operations performed by the component in the system may be based on the PKI framework of the private CA 304.

In the loop 350, which occurs after the component has been received by the operator, the component 312 acquires a certificate issued by the PCDB system 304. In this example, a CSR is issued 352 for the component 312 to the PCDB 306. The CSR 354 is provided to the PCDB CA 308 for signing 356 and the certificate is generated and/or signed 356 for the component 312. The signed certificate is then returned 357 to the PCDB 306. The signed certificate is issued 358 to the component 352 and stored in the local root CA certificate store of the component 312.

FIG. 3E illustrates additional aspects of onboarding the component 312 into the system (e.g., the system 200). The loop 360, performed for components being onboarded, includes receiving 362 a request for root CA certificates of components in the system. Once the request is authenticated (e.g., using the PKI framework of PCDB system 304, the requested root CA certificates (in accordance with the binding information in the PCDB 306) are delivered to the component 312. The root CA certificates received in response to the request 362 are installed 366 into a local root CA certificate store of the component 312.

Once the component 312 is provisioned with root CA certificates in its local root CA certificate store, interactions with other components can occur. Embodiments of the invention thus provide a system wide PCDB system 304, with a PCDB 306 that stores trusted root CA certificates and lists tailored to match the components that are deployed in an operator or private environment. Embodiments of the invention simplify certificate management and verification within the system, allows components from various manufacturers to communicate using the appropriate certificates, and relieves the manufacturer of provisioning the local root certificate stores with root CA certificates. The operator 302 keeps the PCDB 306 up to date over the lifetime of the PCDB 306.

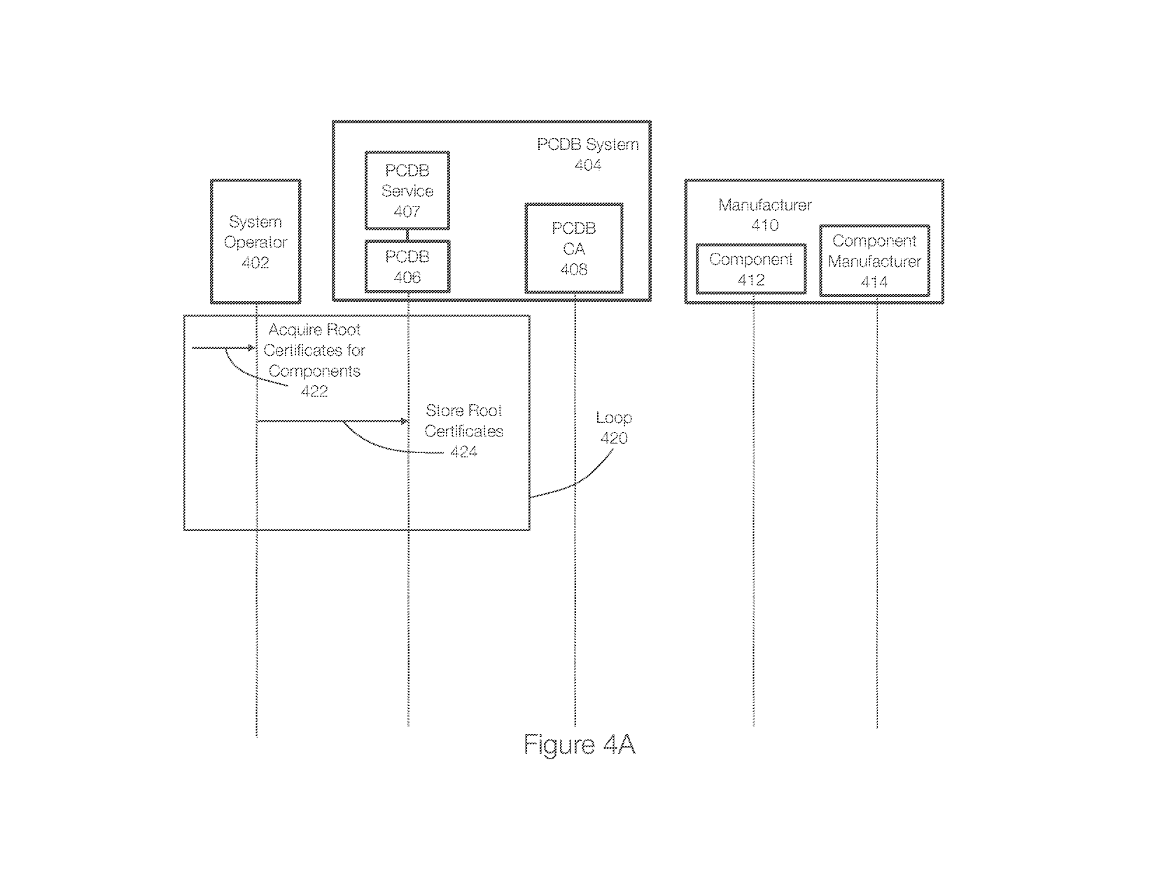

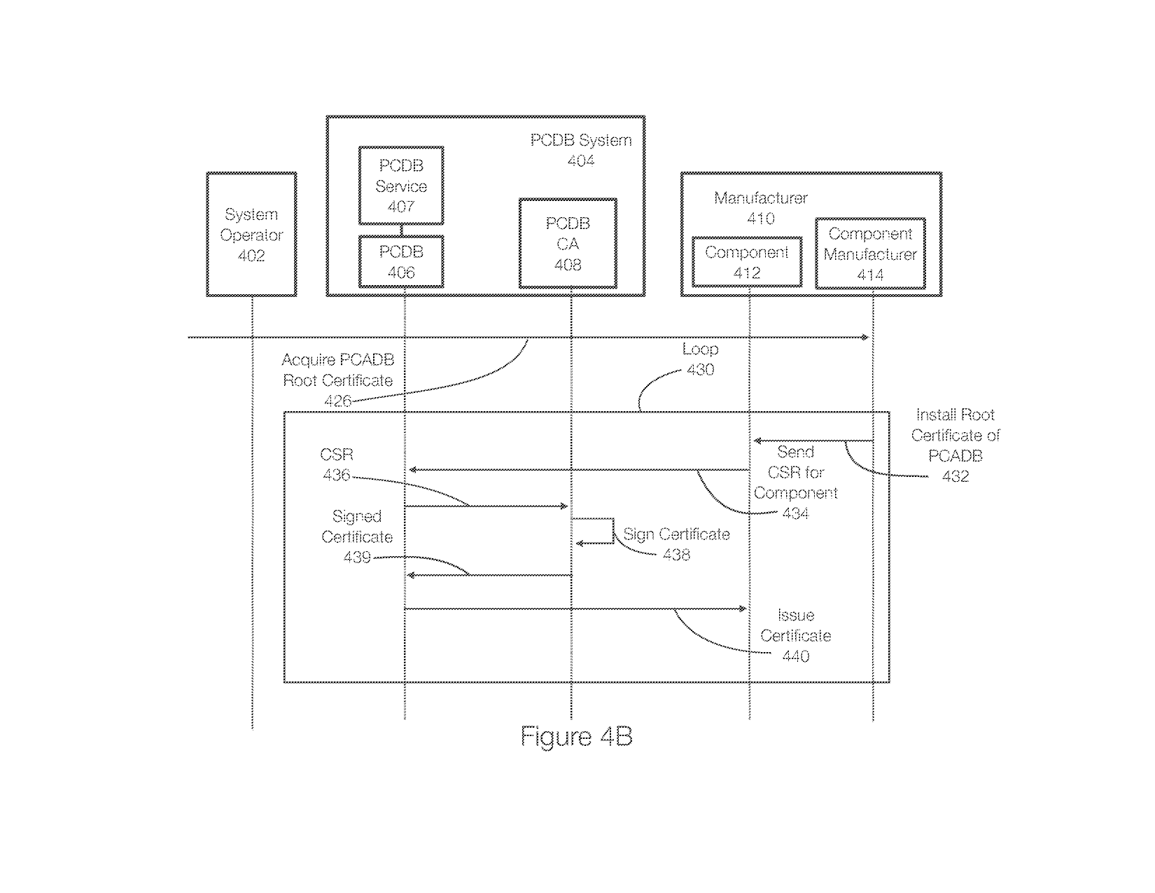

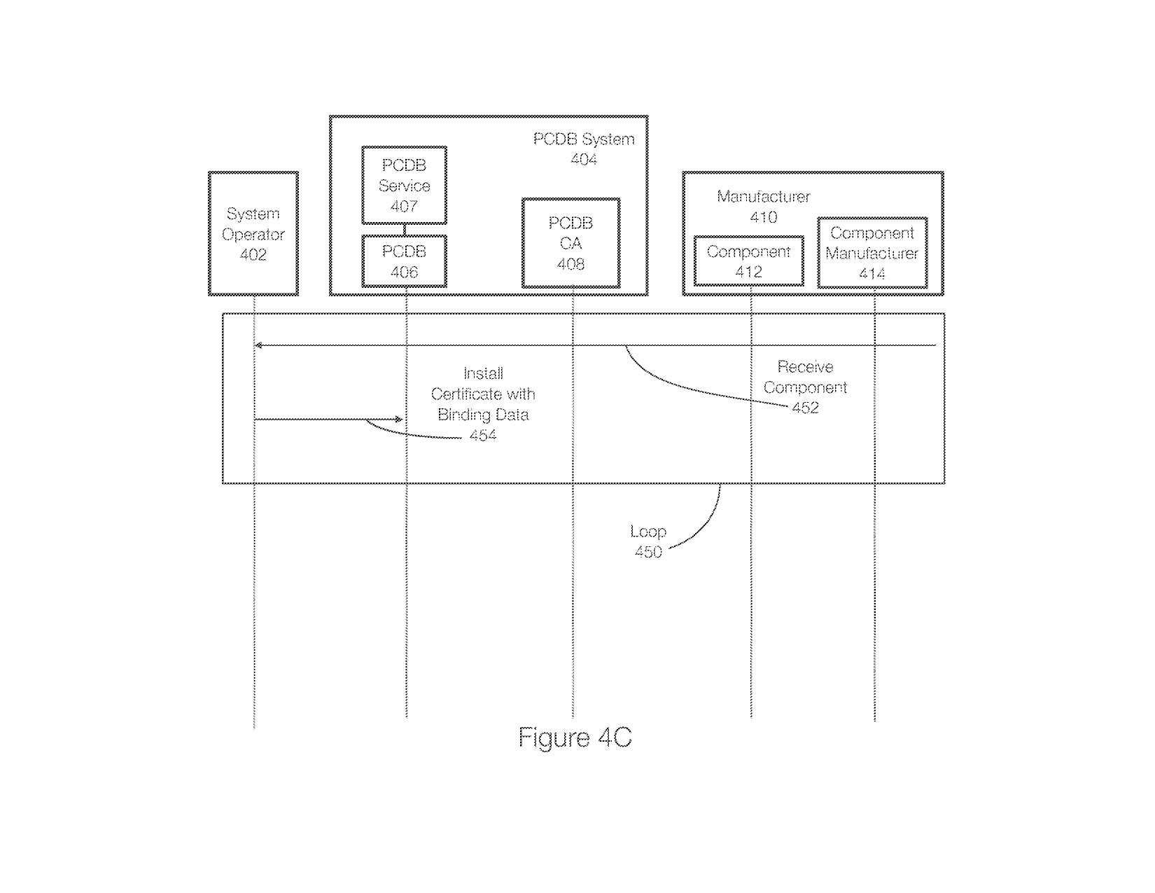

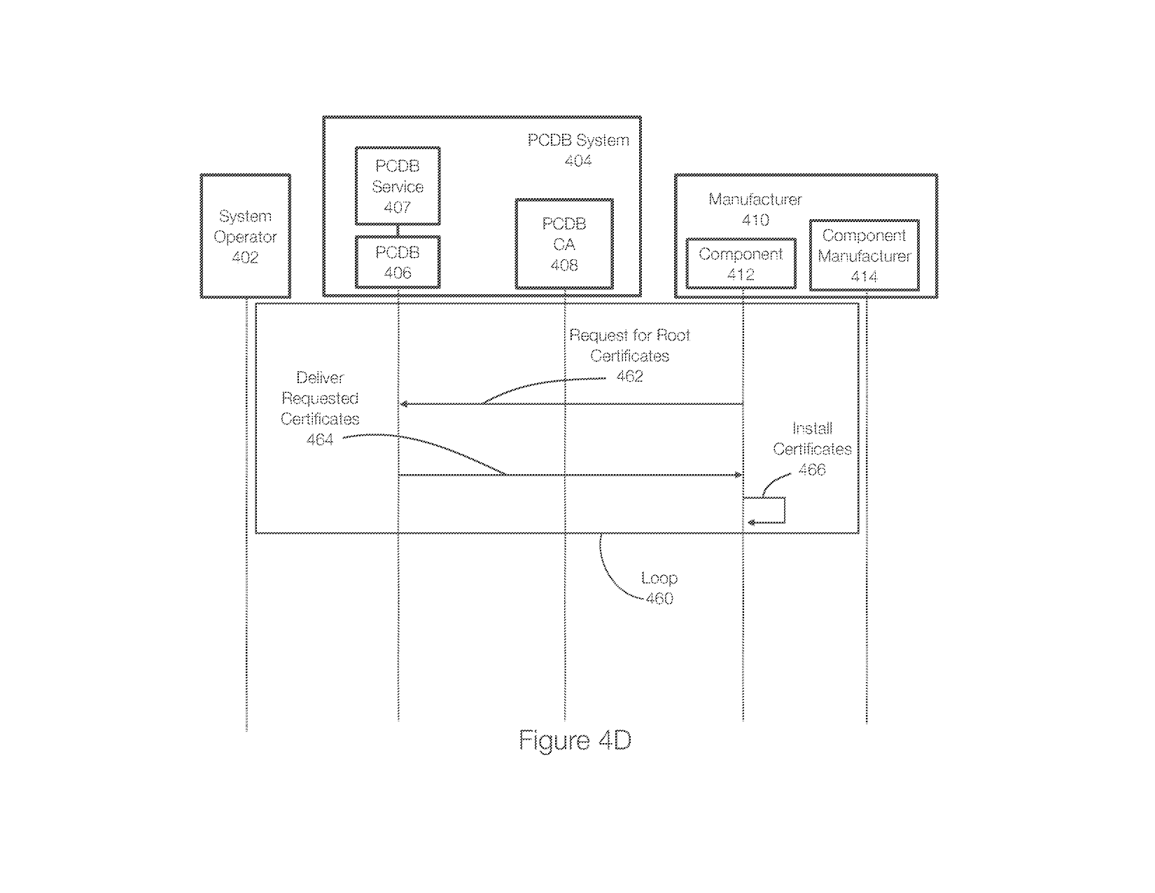

FIGS. 4A, 4B, 4C and 4D disclose additional aspects of provisioning and/or updating local root CA certificate stores of components in a system. FIGS. 4A-4D also reference loops to accommodate multiple components, but are described in the context of a particular component.

In this example of FIGS. 4A-4D, the system operator 402, PCDB system 404, PCDB 406, PCDB service 407, PCDB CA 408, manufacturer 410, component 412, and component manufacturer 414 are examples of, respectively, the system operator 302, PCDB system 304, PCDB 306, PCDB service 307, PCDB CA 308, manufacturer 310, component 312, and component manufacturer 314. In this example, the component manufacturer CA 316 is not used.

FIGS. 4A-4D are similar to FIGS. 3A-3E but differ in that the component manufacturer 414 or component 412 has access to the PCDB 406 while still at the factory or while being manufactured. In FIGS. 3A-3E, the component manufacturer 314 or component 312 does not have access to the PCDB 306 while still at the factory or while being manufactured.

In FIG. 4A, a loop 420 is performed for each component, but is described with respect to a single component. Initially, the root CA certificates for components are acquired 422 in a secure manner by the system operator 402. The acquisition of the root CA certificates 422 may be performed outside of the loop 420. The root CA certificates acquired from various certificate authorities are stored 424 in the PCDB 406.

FIG. 4B occurs at the factory and, in this example, the component manufacturer 414 has access to the PCDB 406. The component manufacturer 414 acquires 426 a root CA certificate of the PCDB 406 or of the PCDB system 404. Once the root CA certificate of the PCDB 406 is acquired, the loop 430 may be performed. The loop 430 is performed such that subsequent use of the certificates can be performed using the PKI infrastructure of the private CA 404 once the components are onboarded.

In the loop 430, the root CA certificate of the PCDB 406 (previously acquired by the component manufacturer 414 at 426) is installed into a local root certificate store of the component 412. The component 412 sends 434 a CSR to the PCDB 406. The PCDB 406 requests the PCDB CA 406 to sign 438 the certificate. The signed certificate generated by the PCDB CA 406 is returned 439 to the PCDB 406. The signed certificate is then issued 440 to the component 412 and installed in the local root CA certificate store of the component 412. Thus, when the component 412 is shipped to the operator, the local root CA certificate store already includes the root CA certificate of the PCDB system 404 (or the PCDB 406) and its own certificate issued by the PCDB system 404.

FIG. 4C discloses aspects the method of FIGS. 4A-4D after a component is shipped to an operator and is being prepared to be onboarded. The loop 450 is thus performed for components received by the operator. In the loop 450, the component 412 is received by the operator. The operator then installs 454 the component’s certificate (issued by the PCDB system 404) and corresponding binding data or information into the PCDB 406.

FIG. 4D discloses additional aspects of onboarding the component 412 into a system. The loop 460 may be performed after authentication which is performed using the certificate of the component (issued by the PCDB system 404) and the root CA certificate of the PCDB system 404. Authentication can be performed within the PKI framework of the PCDB system 404 at least because the certificate of the component 412 was issued by the PCDB system 404 and the root CA certificate of the PCDB 406 (or of the PCDB system 404) was previously installed in the component 412.

The loop 460 includes receiving 462 a request for root CA certificates (the root CA certificates were collected previously by the operator 402) at the PCDB 406 from the component 412 being onboarded. Next, the requested root CA certificates, in accordance with the binding data associated with the component 412, are received by the component 412 and installed 466 into the local root certificate store of the component 412.

A private CA or PCDB system constructed as disclosed herein can ensure that root CA certificates do not become stale at least in part be relieving the factory or manufacturer from configuring the local root CA certificate store during manufacture. If configured by the manufacturer, the local root CA certificate store may require manual updates over the lifecycle of the component. Embodiments further prevent unauthorized components from joining the network at least because they will be unable to obtain the root CA certificates and/or their own certificate from the PCDB system and authentication or verification would fail. Further, root CA certificates can be distributed only to components that need the root CA certificates +using the binding data generated by the operator.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, private CA based operations, certificate management operations, certificate distribution operations, certificate collection operations, certificate lifetime management operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell Technologies Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. In a system that includes multiple components, a method for operating a private certificate database system that includes a private certificate database, the method comprising: receiving a component from a component manufacturer for onboarding into a system, wherein a local root CA certificate store of the first component includes a root CA certificate of the private certificate database system, adding a first certificate of the component into the private certificate database, wherein the first certificate is generated by a manufacturer certification authority associated with and trusted by a manufacturer of the component, adding a root CA certificate associated with the manufacturer certification authority into the private certificate database, generating a second certificate of the first component via the private certificate database system, receiving a request for root CA certificates for other components in the system from the first component, and sending the requested root CA certificates to the first component, wherein the requested root CA certificates are installed in a local root CA certificate store of the first component.

Embodiment 2. The method of embodiment 1, wherein the root CA certificate of the private certificate database system is acquired by the manufacturer in a secure and out-of-band manner.

Embodiment 3. The method of embodiment 1 and/or 2, wherein the root CA certificate of the private certificate database system is installed in a local root CA certificate store of the component by the manufacturer.

Embodiment 4. The method of embodiment 1, 2, and/or 3, wherein the first certificate is generated by the manufacturer certification authority and installed in the component at the factory.

Embodiment 5. The method of embodiment 1, 2, 3, and/or 4, further comprising adding binding data associated with the first certificate into the private certificate database.

Embodiment 6. The method of embodiment 1, 2, 3, 4, and/or 5, wherein the binding data determines which of the other components may interact with the component.

Embodiment 7. The method of embodiment 1, 2, 3, 4, 5, and/or 6, further comprising acquiring the root CA certificates for the other components in a secure manner and adding the root CA certificates to the private certificate database.

Embodiment 8. The method of embodiment 1, 2, 3, 4, 5, 6, and/or 7, further comprising maintaining the private certificate database over its lifetime.

Embodiment 9. The method of embodiment 1, 2, 3, 4, 5, 6, 7, and/or 8, wherein interactions between components in the system are based on a public key infrastructure of the private certificate database system.

Embodiment 10. The method of embodiment 1, 2, 3, 4, 5, 6, 7, 8, and/or 9, further comprising repeating elements (a) through (f) for other components onboarded into the system.

Embodiment 11. The method of embodiment 1, 2, 3, 4, 5, 6, 7, 8, 9, and/or 10, wherein the system is a radio access network, an open radio access network, or a computer network.

Embodiment 12. In a system that includes multiple components, a method for operating a private certificate database system that includes a private certificate database, the method comprising: storing root CA certificates acquired from multiple certification authorities (CAs) into the private certificate database of the private certificate database system, causing a manufacturer to install a root CA certificate of the private certificate database system into a component at a factory, generating a component certificate for the component, by the private certificate database system, while the first component is at the factory, wherein the component certificate is installed in a local root CA certificate store of the component at the factory, receiving the component from the manufacturer at an operator and adding the component certificate to the private certificate database, receiving a request for root CA certificates for other components in the system from the component, and sending the requested root CA certificates to the component, wherein the requested root CA certificates are installed in a local root CA certificate store of the component.

Embodiment 13. The method of embodiment 12, wherein the root CA certificate of the private certificate database system is acquired by the manufacturer in a secure and out-of-band manner.

Embodiment 14. The method of embodiment 12 and/or 13, wherein the root CA certificate of the private certificate database system is installed in a local root CA certificate store of the component by the manufacturer.

Embodiment 15. The method of embodiment 12, 13, and/or 14, further comprising adding binding data associated with the component certificate into the private certificate database.

Embodiment 16. The method of embodiment 12, 13, 14, and/or 16, wherein the binding data determines which of the other components may interact with the component.

Embodiment 17. The method of embodiment 12, 13, 14, 15, and/or 16, further comprising acquiring the root CA certificates for the other components in a secure manner and adding the root CA certificates to the private certificate database.

Embodiment 18. The method of embodiment 12, 13, 14, 15, 16, and/or 17, further comprising maintaining the private certificate database over its lifetime, wherein interactions between components in the system are based on a public key infrastructure of the private certificate database system.

Embodiment 19. The method of embodiment 12, 13, 14, 15, 16, 17, and/or 18, further comprising repeating elements (a) through (f) for other components onboarded into the system.

Embodiment 20. The method of embodiment 12, 13, 14, 15, 16, 17, 18, and/or 19, wherein the wherein the system is a radio access network, an open radio access network, or a computer network.

Embodiment 21. A system, comprising hardware and/or software, operable to perform any of the operations, methods, or processes, or any portion of any of these, disclosed herein.

Embodiment 22. A non-transitory storage medium having stored therein instructions that are executable by one or more hardware processors to perform operations comprising the operations of any one or more of embodiments 1-20.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

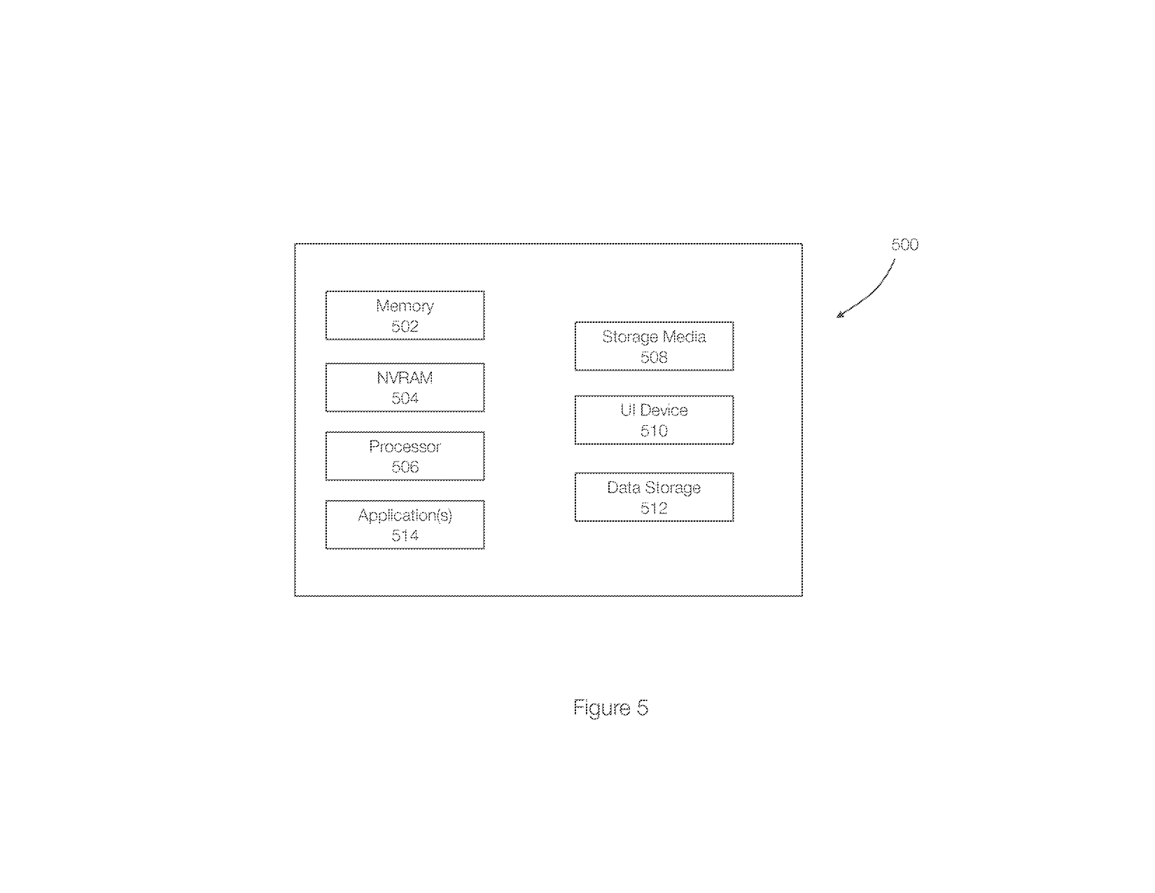

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures. The device 500 may also represent a client-server computing environment, which may be present in networks including the Internet. The device 500 may represent a component.

The described embodiments are to be considered in all respects only as illustrative and not restrictive. All changes which come within the meaning and range of equivalency of the claims are to be embraced within their scope.

What is claimed is:

1. In a system that includes multiple components, a method for operating a private certificate database system that includes a private certificate database, the method comprising:
(a) receiving a component from a component manufacturer for onboarding into a system, wherein a local root store of the first component includes a root CA certificate of the private certificate database system;
(b) adding a first certificate of the component into the private certificate database, wherein the first certificate is generated by a manufacturer certification authority associated with and trusted by a manufacturer of the component;
(c) adding a root CA certificate associated with the manufacturer certification authority into the private certificate database;
(d) generating a second certificate of the first component via the private certificate database system;
(e) receiving a request for root CA certificates for other components in the system from the first component; and
(f) sending the requested root CA certificates to the first component, wherein the requested root CA certificates are installed in a local root CA certificate store of the first component.

2. The method of claim 1, wherein the root CA certificate of the private certificate database system is acquired by the manufacturer in a secure and out-of-band manner.

3. The method of claim 2, wherein the root CA certificate of the private certificate database system is installed in a local root CA certificate store of the component by the manufacturer.

4. The method of claim 3, wherein the first certificate is generated by the manufacturer certification authority and installed in the component at the factory.

5. The method of claim 1, further comprising adding binding data associated with the first certificate into the private certificate database.

6. The method of claim 5, wherein the binding data determines which of the other components may interact with the component.

7. The method of claim 1, further comprising acquiring the root CA certificates for the other components in a secure manner and adding the root CA certificates to the private certificate database.

8. The method of claim 1, further comprising maintaining the private certificate database over its lifetime.

9. The method of claim 1, wherein interactions between components in the system are based on a public key infrastructure of the private certificate database system.

10. The method of claim 1, further comprising repeating elements (a) through (f) for other components onboarded into the system.

11. The method of claim 1, wherein the system is a radio access network, an open radio access network, or a computer network.

12. In a system that includes multiple components, a method for operating a private certificate database system that includes a private certificate database, the method comprising:
(a) storing root CA certificates acquired from multiple certificate authorities into the private certificate database of the private certificate database system;
(b) causing a manufacturer to install a root CA certificate of the private certificate database system into a component at a factory;
(c) generating a component certificate for the component, by the private certificate database system, while the first component is at the factory, wherein the component certificate is installed in a local root CA certificate store of the component at the factory;
(d) receiving the component from the manufacturer at an operator and adding the component certificate to the private certificate database;
(e) receiving a request for root CA certificates for other components in the system from the component; and
(f) sending the requested root CA certificates to the component, wherein the requested root CA certificates are installed in a local root CA certificate store of the component.

13. The method of claim 12, wherein the root CA certificate of the private certificate database system is acquired by the manufacturer in a secure and out-of-band manner.

14. The method of claim 13, wherein the root CA certificate of the private certificate database system is installed in a local root CA certificate store of the component by the manufacturer.

15. The method of claim 12, further comprising adding binding data associated with the component certificate into the private certificate database.

16. The method of claim 15, wherein the binding data determines which of the other components may interact with the component.

17. The method of claim 12, further comprising acquiring the root CA certificates for the other components in a secure manner and adding the root CA certificates to the private certificate database.

18. The method of claim 12, further comprising maintaining the private certificate database over its lifetime, wherein interactions between components in the system are based on a public key infrastructure of the private certificate database system.

19. The method of claim 12, further comprising repeating elements (a) through (f) for other components onboarded into the system.

20. The method of claim 12, wherein the wherein the system is a radio access network, an open radio access network, or a computer network.
